(19) United States
(12) Patent Application Publication
(10) Pub. No.: US 2016/0274932 A1
(43) Pub. Date: Sep. 22, 2016

(54) MULTICORE SYSTEM AND SCHEDULING METHOD OF THE SAME

(71) Applicant: Electronics and Telecommunications Research Institute, Daejeon (KR)

(72) Inventor: Song Woo SOK, Daejeon (KR)

(21) Appl. No.: 15/071,817

(22) Filed: Mar. 16, 2016

(30) Foreign Application Priority Data
Mar. 20, 2015 (KR) 10-2015-0039002

(51) Int. Cl. G06F 9/455

(52) U.S. Cl. CPC G06F 9/45558; G06F 2009/45579

(57) ABSTRACT

Provided herein is a method for improving Virtual Machine input/output performance of a server configured to execute a plurality of Virtual Machines, a scheduling method of a multicore system according to an embodiment of the present disclosure including measuring frequency of input/output requests of each of a plurality of Virtual Machines; determining whether or not there is a Virtual Machine of which the frequency of input/output requests is or more than a predetermined threshold value; moving, if frequency of input/output requests of a first Virtual Machine is or more than the predetermined threshold value, the first Virtual Machine to a first core where a Dom0 Virtual Machine is being executed; and shortening a scheduling cycle of the first core where the Dom0 Virtual Machine is being executed, thereby dynamically adjusting the scheduling cycles of the Virtual Machines, and rearranging the Virtual Machines between the cores in the multicore system, so as to improve the input/output performance of the Virtual Machines.

### CROSS-REFERENCE TO RELATED APPLICATION

The present application claims priority to Korean patent application number 10-2015-0039002, filed on Mar. 20, 2015, the entire disclosure of which is incorporated herein in its entirety by reference.

### BACKGROUND

1. Field of Invention

Various embodiments of the present invention relate to a method for improving input/output performance of a server configured to execute a plurality of Virtual Machines and a multicore system that includes the same.

2. Description of Related Art

Virtualization technology refers to a technology wherein a hardware of a physical apparatus is embodied as a plurality of virtualized hardware so that a plurality of Virtual Machines (VM) each having its own operating system in the one physical apparatus may operate in one host computer. Each of the different types of operating systems may operate independently in the virtualized environment that the virtualization technology provides.

A virtualization system where such a virtualization technology is applied may include a plurality of Virtual Machines (VM) and a hypervisor. Herein, the hypervisor may be referred to as a Virtual Machine Monitor (VMM). The hypervisor manages each Virtual Machine to share the computer resources. That is, the hypervisor may determine which Virtual Machine of all the Virtual Machines to execute through the physical CPU.

Meanwhile, the hypervisor may schedule such that the CPU resources are used by only one Virtual Machine (VM) at a time, and such that at every certain different period of time the CPU resources are used by a different Virtual Machine (VM). Furthermore, the hypervisor may divide the memory resources spatially for each Virtual Machine and isolate the divided memory resources from one another.

Furthermore, since an input/output device is often approachable by one subject only, the hypervisor or a certain Virtual Machine (for example, Dom0) may manage the input/output device exclusively. In addition, execution of an input/output request by a general Virtual Machine using the virtual input/output device may be recognized by the hypervisor or the operating system of the Dom0 to execute the input/output request instead of the Virtual Machine. That is, the general Virtual Machine uses the input/output device indirectly.

FIG. 1 is a view illustrating an example of an input/output method of Virtual Machines.

The example illustrated in FIG. 1 is based on an assumption that of a Dom0 130 and a hypervisor 120, the Dom0 130 manages the actual device. Herein, the Dom0 130 is a special domain where a device driver may be installed, and that manages other Virtual Machines (domains) 140, 150, 160 by communicating with the hypervisor 120. Furthermore, the general Virtual Machines 140, 150, 160 may be DomUs that are not authorized to approach the physical input/output device 10 and that are generally generated by a user. That is, the Dom0 130 may perform an input/output using the input/output device and the hypervisor 120 (135) directly whereas execution of an input/output request by the general Virtual Machines 140, 150, 160 may be recognized by the operating system of the Dom0 130 so that the Dom0 130 may execute the input/output instead of the general Virtual Machines (145, 155, 165).

That is, except for the Dom0 130, for the general Virtual Machines 140, 150, 160 to perform an input/output, the process may be as follows. For example, a first general Virtual Machine 140 may transmit an input/output command to the Dom0 130 using a virtual input/output device. Accordingly, the Dom0 130 would receive the input/output command, and approach the actual input/output device to execute the input/output. Then, when the input/output process of the actual input/output device is completed, the Dom0 130 may notify the first general Virtual Machine 140 about the result. Furthermore, the first general Virtual Machine 140 may receive the result from the Dom0 130 and recognize that the input/output command has been received.

For the general Virtual Machines 140, 150, 160 to execute an input/output in the aforementioned order, the Dom0 130 and the general Virtual Machines 140, 150, 160 must be executed alternately and process the operation.

Furthermore, since the number of input/output requests that may be processed simultaneously is limited, the more the time for processing the entire input/outputs is shortened, the more improved the input/output performance will become.

Meanwhile, changing the Virtual Machine to be executed is referred to as switching, and selecting and executing a suitable Virtual Machine is referred to as scheduling. Herein, although switching takes a very short period of time, if the switching is executed too often, a considerable amount of CPU time will be consumed. Therefore, switching the Virtual Machines too often may lead to a problem of reducing the CPU execution time for the Virtual Machines, thereby deteriorating the performance.

FIG. 2 is a view illustrating an example of a conventional virtualization technology.

Referring to FIG. 2, in the case of a conventional virtualization technology of Xen, Dom0 and Virtual Machines may be switched for execution on a relatively long cycle of several scores of ms. For example, in the case of switching between three general Virtual Machines and a Dom0 on a cycle of 30 ms as illustrated, a delay time of processing an input/output may reach up to 90 ms.

In the aforementioned setting, although there may be not much difference in the CPU performance compared to when an operating system is executed solely without virtualization, the input/output performance may deteriorate considerably.

FIG. 3 is a view illustrating another example of the virtualization technology.

Referring to FIG. 3, it is possible to shorten a scheduling cycle of a Virtual Machine Dom0 that processes an input/output, and increase a frequency of the scheduling. By doing this, it is possible to reduce a time of response of a general Virtual Machine, and improve the input/output performance as well. For example, as illustrated, by shortening the scheduling cycle of a Virtual Machine that processes an input/output, it is possible to shorten a response time of a conventional general Virtual Machine.

However, in such a case, although the input/output performance may be improved compared to the technology explained with reference to FIG. 2, the scheduling cycles of other Virtual Machines will still remain long, and thus there will be limitation in improving the performance.

FIG. 4 is a view illustrating another example of the virtualization technology.

The method illustrated in FIG. 4 is a method applicable to a multicore system. This is a method of shortening a scheduling cycle of at least one virtual CPU being executed in at least one certain physical core in order to shorten a response time of processing an input/output. According to this method, in the virtual machine, the virtual CPU with a shortened scheduling cycle is in charge of the input/output performance, thereby improving the input/output performance.

For example, referring to FIG. 4, it is possible to shorten a scheduling cycle of virtual CPUs 417, 427 executed in a certain physical core in an actual physical hardware 440. Furthermore, virtual CPU 415, 425 executed in a remaining physical core 443 may operate according a general scheduling cycle (that is, a scheduling cycle that is longer than the virtual CPU 417, 427 executed in a certain physical core 445). Herein, the certain physical core 445 may be referred to as for example, a turbo core. Furthermore, the virtual CPU 417, 427 being executed in the turbo core 445 of virtual machines 410, 420 may be referred to as a virtual turbo machine (vTurbo). Furthermore, as mentioned above, the vTurbo 417, 427 may be in sole charge of processing an input/output within each Virtual Machine 410, 420.

However, in such a virtualization technology, the operating system of the Virtual Machine needs to be modified, and since the number of the turbo core 445 is set to a certain number, when there is not so much input/output requests, there may be a problem of wasting the CPU resources due to the fast switching overhead.

### SUMMARY

A purpose of the present disclosure is to resolve the aforementioned problems of prior art, that is to dynamically adjust scheduling cycles of Virtual Machines, and rearrange the Virtual Machines between cores in a multicore system, thereby improving input/output performance of the Virtual Machines.

Another purpose is to provide a Virtual Machine scheduling method for efficient use of CPU resources.

Another purpose is to arrange the Dom0 Virtual Machine that must operate to process an input/output when an amount of input/output requests of the Virtual Machine increases and the Virtual Machine that requested input/output in the same core, and shortening the scheduling cycle of that core, thereby shortening the response time of input/output processing and improving the input/output performance.

Another purpose is to arrange Virtual Machines that did not request an input/output to another core, thereby optimizing the input/output performance of other Virtual Machines with much input/output requests, and optimizing processing performance of the Virtual Machines with not much input/output requests.

Another purpose is to provide the user convenience of using Virtual Machines without having to modify their operating systems.

According to an embodiment of the present disclosure, there is provided a scheduling method of a multicore system, the method including measuring frequency of input/output requests of each of a plurality of Virtual Machines; determining whether or not there is a Virtual Machine of which the frequency of input/output requests is or more than a predetermined threshold value; moving, if frequency of input/output requests of a first Virtual Machine is or more than the predetermined threshold value, the first Virtual Machine to a first core where a Dom0 Virtual Machine is being executed; and shortening a scheduling cycle of the first core where the Dom0 Virtual Machine is being executed according to a predetermined value.

Furthermore, the moving the first Virtual Machine may include moving, if a core where the first Virtual Machine is being executed is not the same as the first core where the Dom0 Virtual Machine is being executed, the first Virtual Machine to the first core.

Furthermore, the method may further include, moving, if frequency of input/output requests of a second Virtual Machine is smaller than the predetermined threshold value in the first core, the second Virtual Machine to a second core.

Furthermore, the shortening the scheduling cycle of the first core may include, shortening, if a scheduling cycle of the first core have not been shortened according to the predetermined value, the scheduling cycle of the first core according to the predetermined value.

Furthermore, the shortening the scheduling cycle may further include determining whether or not the number of Virtual Machines of which the frequency of input/output requests is or more than the predetermined threshold value is or more than a predetermined number of Virtual Machines; and shortening, if the number of the Virtual Machines of which the frequency of input/output requests is or more than the predetermined threshold value is more than the predetermined number of Virtual Machines, scheduling cycles of the first core and the second core according to the predetermined value.

According to another embodiment of the present disclosure, there is provided a multicore system including a plurality of Virtual Machines (VMs); a hypervisor configured to provide a virtualized execution environment for each of the plurality of Virtual Machines; an input/output device; and a plurality of cores configured to execute the plurality of Virtual Machines; wherein the hypervisor measures frequency of input/output requests of each of the plurality of Virtual Machines, determines whether or not there is a Virtual Machine of which the frequency of input/output requests is or more than a predetermined threshold value, and moves, if frequency of input/output requests of a first Virtual Machine is or more than the predetermined threshold value, the first Virtual Machine to a first core where a Dom0 Virtual Machine is being executed, and controls such that a scheduling cycle of the first core where the Dom0 Virtual Machine is being executed is shortened according to a predetermined value.

According to the aforementioned embodiments of the present disclosure, it is possible to dynamically adjust scheduling cycles of Virtual Machines, and rearrange the Virtual Machines between cores in a multicore system, thereby improving input/output performance of the Virtual Machines.

Furthermore, it is possible to provide a Virtual Machine scheduling method for efficient use of CPU resources.

Furthermore, it is possible to arrange the Dom0 Virtual Machine that must operate to process an input/output when the frequency of input/output requests of the Virtual Machine increases and the Virtual Machine that requested input/output in the same core, and shorten the scheduling cycle of that core, thereby shortening the response time of input/output processing and improving the input/output performance.

Furthermore, it is possible to arrange Virtual Machines that did not request an input/output to another core, thereby optimizing the input/output performance of other Virtual Machines with much input/output requests, and optimizing processing performance of the Virtual Machines with not much input/output requests.

Furthermore, it is possible to provide the user convenience of using Virtual Machines without having to modify their operating systems.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a view illustrating an example of an input/output method of Virtual Machines;

FIG. 2 is a view illustrating an example of a conventional virtualization technology;

FIG. 3 is a view illustrating another example of the virtualization technology;

FIG. 4 is a view illustrating another example of the virtualization technology

FIGS. 5 to 9 are views illustrating an example of processing of operation of a multicore system where the virtualization technology according to an embodiment of the present disclosure has been applied; and

FIG. 10 is a view illustrating an example of a scheduling method of a multicore system according to an embodiment of the present disclosure.

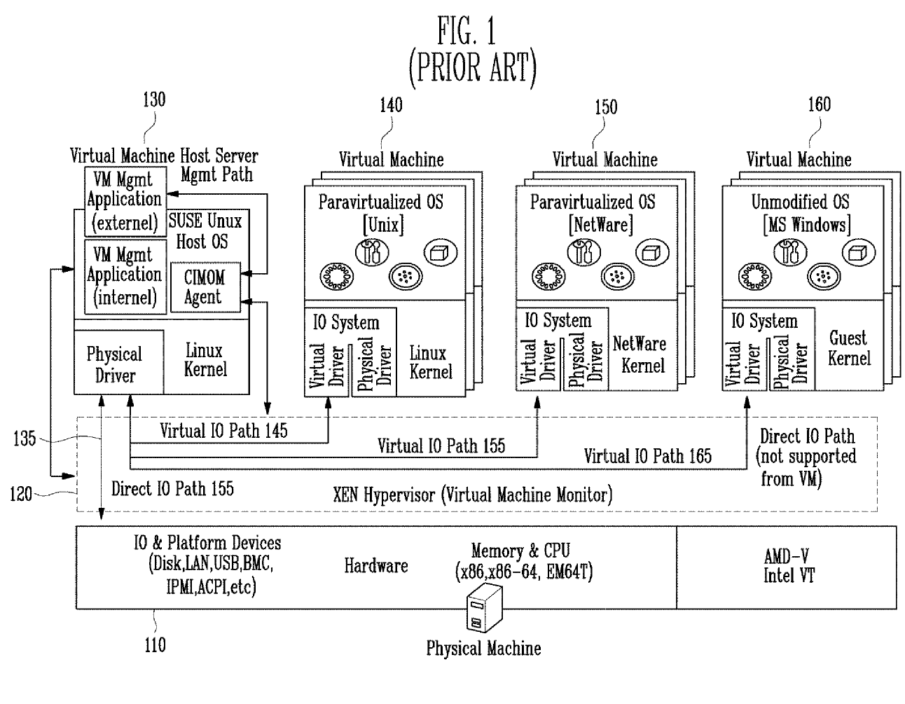

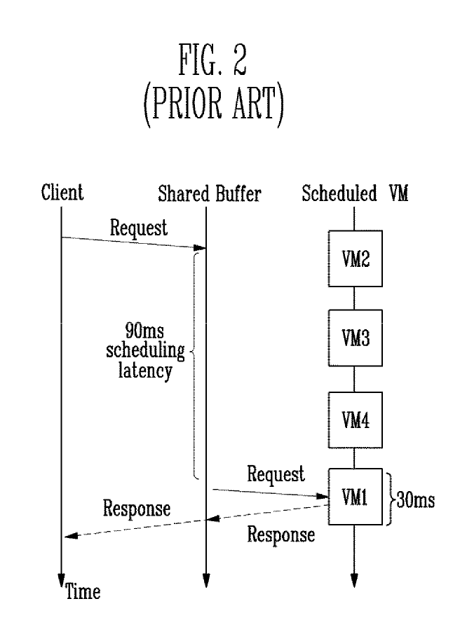

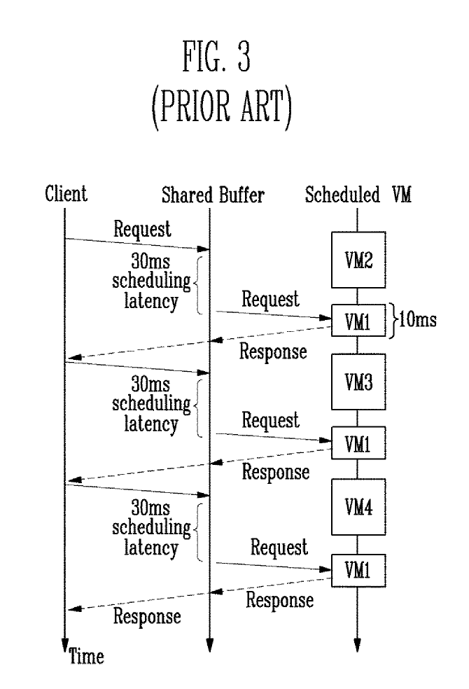

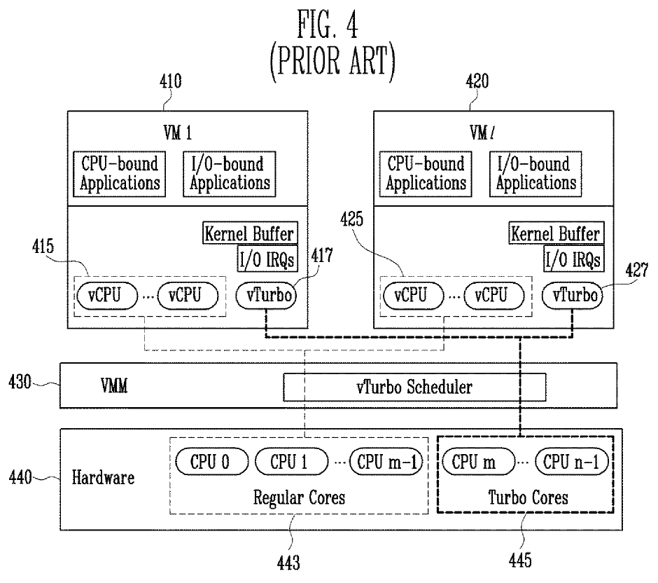

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

According to an embodiment of the present disclosure, it is possible to control a scheduling cycle of a hypervisor that manages a Virtual Machine (VM) in a multicore system where the virtualization technology has been applied, per core. Furthermore, it is possible to measure frequency of input/output requests of a Virtual Machine, and allocate a Virtual Machine with many input/output requests to a certain core having a short scheduling cycle, thereby improving the input/output performance of the Virtual Machines. Herein, the hypervisor may be referred to as a Virtual Machine Monitor (VMM). The hypervisor manages each Virtual Machine to share the computer resources. That is, the hypervisor may determine which Virtual Machine to execute through which physical CPU.

Meanwhile, in explaining a multicore system according to an embodiment of the present disclosure where the virtualization technology has been applied, an assumption will be made on the following conditions. However, not all the following conditions need to be satisfied to apply the present disclosure. It is just for the sake of easy explanation. Thus, even when the following conditions are not satisfied, those skilled in the art may be able to apply an embodiment of the present disclosure to a multicore system where the virtualization technology has been applied, and improve the input/output performance of the Virtual Machines. For example, it may be possible to apply the present disclosure to a case where the Dom0 Virtual Machine is movable between cores.

A first precondition is a multicore system where the virtualization technology has been applied. Furthermore, the hypervisor may be in charge of scheduling all the Virtual Machines including the Dom0 Virtual Machine. Herein, the longer the scheduling cycle is the higher the processing performance can be, and the shorter the scheduling cycle is the higher the input/output performance can be. Furthermore, the Virtual Machine that takes charge of the actual input/output for the Virtual Machines may be the Dom0 Virtual Machine. All the Virtual Machines transmit input/output requests to the Dom0 Virtual Machine through the hypervisor, and thus the hypervisor may measure frequency of input/output requests through the hypervisor. The Dom0 Virtual Machine is executed by a predetermined core, and it is a precondition that the Dom0 Virtual Machine will not be moved between cores. Furthermore, the hypervisor may adjust a scheduling cycle per core, and move a Virtual Machine between cores and perform scheduling.

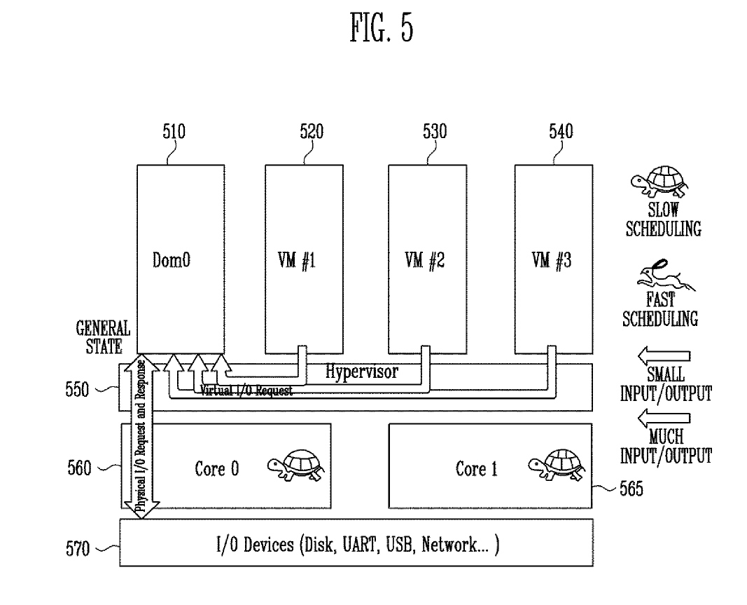

FIGS. 5 to 9 are views illustrating an example of operating a multicore system where the virtualization technology has been applied according to an embodiment of the present disclosure.

Referring to FIG. 5, the multicore system according to an embodiment of the present disclosure may include a plurality of cores 560, 565, hypervisor 550, a plurality of Virtual Machines 510, 520, 530, 540, and input/output device 570. Four Virtual Machines 510, 520, 530, 540 are illustrated in FIG. 5, but without limitation, and thus it is a matter of course that more or fewer Virtual Machines may be included in the multicore system.

Herein, the first Virtual Machine 510 may be a special Virtual Machine, that is, a Dom0 Virtual Machine. Furthermore, as illustrated, the Dom0 Virtual Machine 510 may approach the input/output device 570 and perform an input/output. Furthermore, the Dom0 Virtual Machine 510 is a special domain where a device driver may be installed so that it may manage other general Virtual Machines (domains) 520, 530, 540 by communicating with the hypervisor 550.

Furthermore, the second Virtual Machine 520, third Virtual Machine 530, and fourth Virtual Machine 540 are general Virtual Machines, and they may be DomUs. These Virtual Machines are not authorized to approach the physical input/output device 570 directly, but may perform an input/output using a virtual input/output device. And then, the hypervisor 550 or an operating system of the Dom O Virtual Machine 510 may recognize the input/output request and perform an input/output instead. That is, the general Virtual Machines 520, 530, 540 use the input/output device 570 indirectly. For example, the second Virtual Machine (may be hereinafter referred to as a first general Virtual Machine) 520 may transmit an input/output command to the Dom0 Virtual Machine 510 through the hypervisor 550 using a Virtual input/output device. Accordingly, the Dom0 Virtual Machine 510 may receive the input/output command, and approach the actual input/output device 570 and execute the input/output. Then, when the transmission of the input/output command to the actual input/output device is completed, the Dom0 Virtual Machine 570 may transmit a result of transmission of the input/output command to the first general Virtual Machine 520. Then, the DomU Virtual Machine 520 may receive the result of transmission of the input/output command from the Dom0 Virtual Machine 510 and recognize that the input/output operation has been done.

That is, the Dom0 Virtual Machine 510 may perform an input/output using the input/output device 570 directly and the hypervisor 550, whereas the general Virtual Machines 520, 530, 540 perform an input/output using a virtual input/output device, and then the operating system of the Dom0 Virtual Machine 510 recognizes the input/output command and executes the command.

Furthermore, the Dom0 Virtual Machine 510 may be executed by a first core 560. The first general Virtual Machine 520 may be executed by the first core 560 as well, while the second general Virtual Machine 530 and the third general Virtual Machine 540 are executed by a second core 565. However, this is only an assumption, and thus in an embodiment, the first general Virtual Machine 520 to the third general Virtual Machine 540 may be executed in the second core 565.

Herein, when there is just a small amount of input/output requests from all the Virtual Machines, that is the special Virtual Machine, Dom0 Virtual Machine 510, and the general Virtual Machines 520, 530, 540, the hypervisor 550 may set a scheduling cycle of each core 560, 565 to be long. That is, the hypervisor 550 may set a slow scheduling for each core 560, 565. Thus, processing performance of each Virtual Machine 510, 520, 530, 540 may be optimized.

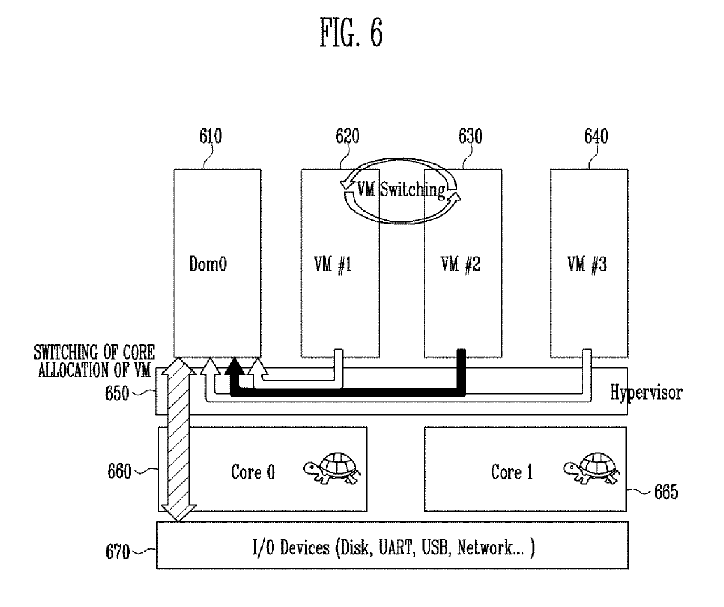

Meanwhile, as illustrated in FIG. 6, there may be a case where some Virtual Machines have large amounts of input/output requests. In FIG. 6, the second general Virtual Machine (third Virtual Machine) has an increased amount of input/output requests. For this purpose, the hypervisor 650 may determine whether or not there is a Virtual Machine of which the frequency of input/output requests is or more than a predetermined threshold value (the same applies to determining whether or not a Virtual Machine has the frequency of input/output requests that is or more than the threshold value). That is, the hypervisor 650 may measure frequency of input/output requests of all the Virtual Machines, and accordingly, in an embodiment, determine whether the increased input/output requests is being retained for or more than a predetermined period of time. Furthermore, in an embodiment, the hypervisor 650 may determine whether or not a core of the Virtual Machine 630 with the increased amount of input/output requests is the same core as the core 660 (that is, the first core) where the Dom0 610 is being executed.

If there is a Virtual Machine of which an amount of input/output requests is or more than the threshold value, the hypervisor may move that Virtual Machine of which the amount of input/output requests is or more than the threshold value to the core where the Dom0 is being executed.

That is, as illustrated in FIG. 6, supposing an amount of input/output requests of the second general Virtual Machine 630 is or more than the predetermined threshold value, and the second general Virtual Machine 630 is being executed in the second core 665, the hypervisor 60 may move the second general Virtual Machine 630 of which the amount of input/output requests has increased to be or more than the predetermined threshold value to the first core 660 where the Dom0 610 is being executed.

Furthermore, in an embodiment, the hypervisor 650 may determine whether or not there is a Virtual Machine having a smaller amount of input/output requests than the predetermined threshold value in the first core 660 where the Dom0 Virtual Machine 610 is being executed (the same applies to determining whether or not a Virtual Machine has an amount of input/output requests that is smaller than the threshold value). Referring to FIG. 6, the first general Virtual Machine 620 may have an amount of input/output requests that is smaller than the predetermined threshold value, and this information may be sensed by the hypervisor 650. In such a case, the hypervisor 650 may switch core allocations of the second general Virtual Machine 630 having an amount of input/output requests that is or more than the threshold value, and the first general Virtual Machine 620 having an amount of input/output requests that is smaller than the threshold value. That is, the first general Virtual Machine 620 may be allocated to be executed in the second core 665, while the second general Virtual Machine 630 is allocated to be executed in the first core 660.

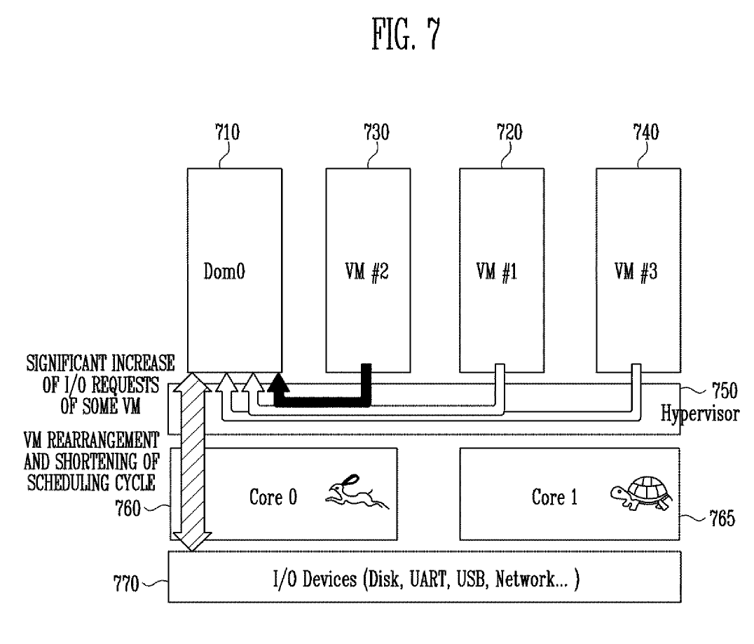

Then, as illustrated in FIG. 7, the hypervisor 750 may expedite a scheduling cycle of the first core 760 where the Dom0 Virtual Machine 710 belongs to. That is because, since the Dom0 Virtual Machine 710 is in charge of actual input/outputs, shortening the scheduling cycle of the Dom0 Virtual Machine 710 is necessary to improve the input/output performance. Herein, the input/output performance of the Virtual Machine of that core may improve, but the processing performance may slightly deteriorate due to an increase of scheduling overhead. Therefore, by moving the Virtual Machines having small amounts of input/output requests of among those belonging to the same core as the Dom0 710 to another core, it is possible to prevent deterioration of the processing performance caused by shortening the scheduling cycle.

That is, referring to FIG. 7, the hypervisor 750 may shorten the scheduling cycle of the first core 760 where the Dom0 710 and the second general Virtual Machine 730 having a large amount of input/output requests are being executed. Herein, the scheduling cycle may be shortened according to a predetermined value or rate, and in an embodiment, the scheduling cycle may be shortened according to the amount of input/output requests of the virtual cores. Furthermore, in an embodiment, the scheduling cycle may be determined according to the number of Virtual Machines being executed in the core 760 where the Dom0 710 belongs to. For example, the more number of Virtual Machines there are, the more the scheduling cycle may be shortened. On the other hand, a scheduling cycle of the second core 765 where the Dom0 710 and the second general Virtual Machine 730 having a large amount of input/output requests belong to may not be shortened but retained to be long. That is, a scheduling cycle of the second core 765 where the third Virtual Machine 740 having not much input/output requests is being executed may be retained to be long, thereby preventing the processing performance from deteriorating. Herein, in an embodiment, for the first general Virtual Machine 720 that is being executed in the first core 760 and that has a smaller amount of input/output requests than the threshold value, the hypervisor 750 may perform a switching such that the first general Virtual Machine 720 may be executed in the second core 765. In such a case, the processing performance of the first general Virtual Machine 720 may also be prevented from deteriorating.

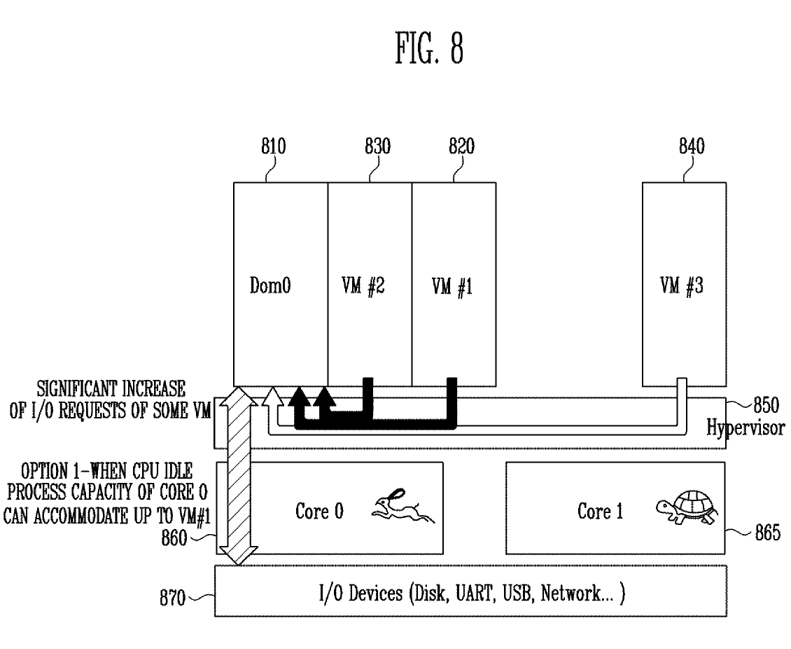

Meanwhile, referring to FIG. 8, there may be a case where while the second general Virtual Machine 830 is being executed in the first core 860 having a shortened scheduling cycle, in addition to the second general Virtual Machine 830, the amount of input/output requests of some general Virtual Machines being executed in the second core 865 has increased. FIG. 8 illustrates an example where the amount of input/output requests of the first general Virtual Machine 820 has increased. Herein, the hypervisor 850 may move the first general Virtual Machine 820 of which the amount of input/output requests has increased to the first core 860 where the Dom0 Virtual Machine 810 is being executed. Herein, the hypervisor 850 may determine whether or not the amount of input/output requests of the second Virtual Machine 830 being executed in the first core 860 has fallen below the predetermined threshold value. If the amount of input/output requests of the second general Virtual Machine 830 is below the threshold value, the hypervisor 850 may move the second general Virtual Machine 830 to the second core 860. However, if the amount of input/output requests of the second general Virtual Machine 830 is not below the threshold value, the hypervisor 850 may move the first general Virtual Machine 820 to the first core 860 while retaining the second general Virtual Machine 830 in the first core 860.

Herein, since the scheduling cycle of the first core 860 where the Dom0 810 is being executed has already been shortened, the hypervisor 850 may not shorten the scheduling cycle of the first core 860. However, in an embodiment, the hypervisor 850 may further shorten the scheduling cycle of the first core 860 since the first general Virtual Machine 820 has been additionally allocated to the first core 860.

In an embodiment, the hypervisor 850 may determine whether or not an idle Virtual Machine processing capacity of the first core 860 is capable of accommodating the first general Virtual Machine 820 as well. Only when the first core 860 is capable of accommodating the first general Virtual Machine 820 on top of the Dom0 Virtual Machine 810 and the second general Virtual Machine 823, the hypervisor 850 may move the first general Virtual Machine 820 to the first core 860.

In such a case, the processing performance of the Virtual Machines may further deteriorate as the number of the Virtual Machines of the first core 860 where the Dom0 810 belongs to increased, but still the input/output performance may be maintained high. Furthermore, the scheduling cycle of the second core 865 where the third Virtual Machine 840 having not much input/output requests belongs to may be retained long, thereby preventing the processing performance from deteriorating.

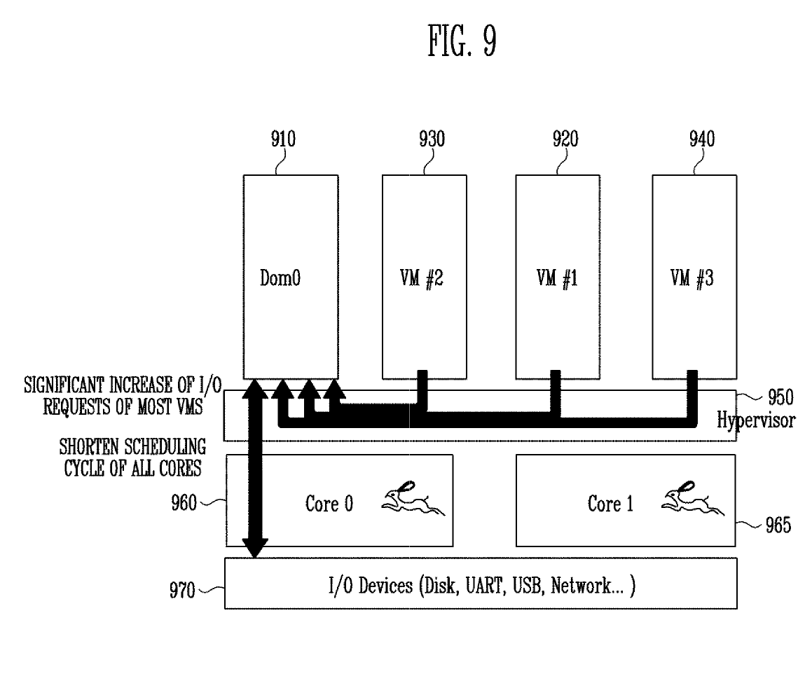

FIG. 9 illustrates a case where most of the Virtual Machines have large amounts of input/output requests. It is a case where the first general Virtual Machine 920, second general Virtual Machine 930, and third general Virtual Machine 940 all have large amounts of input/output requests. In this case, the hypervisor 950 may shorten the scheduling cycles of all cores 960, 965. That is, the input/output performance of all the Virtual Machines 920, 930, 940 may be optimized.

In an embodiment, the hypervisor 950 may determine whether or not the number of Virtual Machines having an amount of input/output requests that is or more than the predetermined threshold value is or more than a predetermined number. Otherwise, the hypervisor 950 may determine whether or not an idle Virtual Machine process capacity of the first core 960 may accommodate all the Virtual Machines having an amount of input/output requests that is or more than the threshold value. If the first core 960 is not capable of accommodating all the Virtual Machines having an amount of input/output requests that is or more than the threshold value and/or if the number of Virtual Machines having an amount of input/output requests that is or more than the threshold value is or more than the predetermined number of Virtual Machines, the hypervisor 950 may shorten the scheduling cycle of the second core 965 in addition to the first core 960.

Herein, in a case where the multicore system includes three or more cores, the hypervisor 950 may determine the number of cores of which the scheduling cycle should be shortened according to the number of Virtual Machines with an amount of input/output requests that is or more than the threshold value. For example, if it is possible to accommodate all the Virtual Machines with an increased amount of input/output requests in two cores, the hypervisor 950 may shorten the scheduling cycle of the two cores, but if it is not possible to accommodate all the Virtual Machines with an increased amount of input/output requests in the two cores, the hypervisor 950 may shorten the scheduling cycle of three cores. In such a case, without having to move the Virtual Machine of which an amount of input/output requests is or more than the threshold value to the core 960 where the Dom0 is being executed, the hypervisor 950 may retain the Virtual Machine in another core having a shortened scheduling cycle. Otherwise, if there are two cores of which the scheduling cycles have been shortened and a core of which the scheduling cycle has not been shortened, the hypervisor 950 may move the Virtual Machines having an amount of input/output requests that is or more than the threshold value to one of the two cores with the shortened scheduling cycle. Herein, moving the Virtual Machines having an amount of input/output requests that is or more than the threshold value may be performed sequentially in an order based on identification information of the Virtual Machines, or based on the order of amounts of the input/output requests. For example, the Virtual Machine having the most input/output requests may be moved to the core 960 where the Dom0 belongs to, and the Virtual Machine with a relatively small amount of input/output requests may be moved to another core with a shortened scheduling cycle and not the core where the Dom0 belongs to.

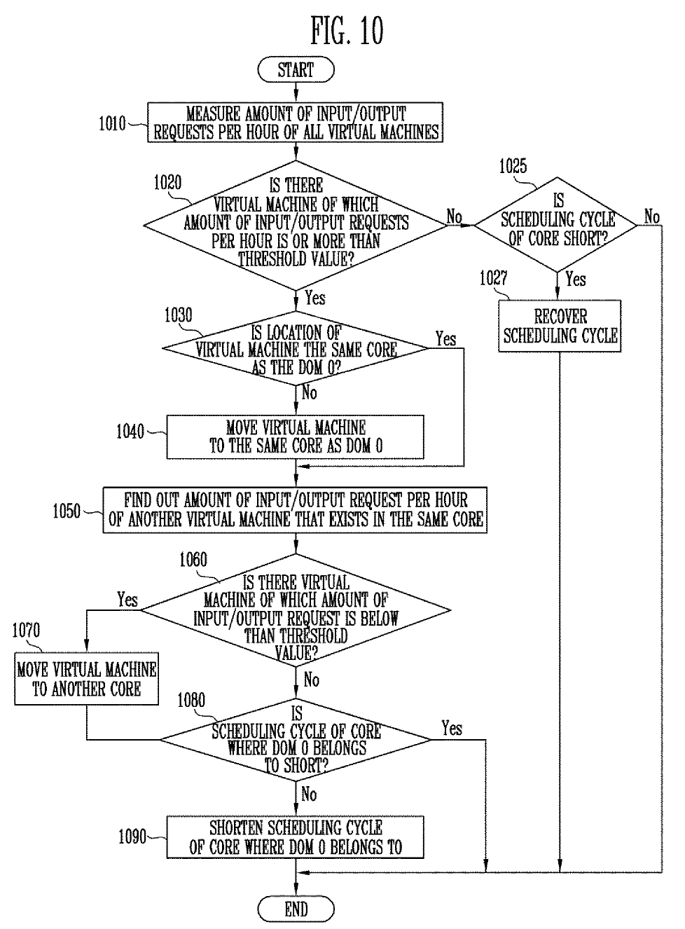

FIG. 10 is a view illustrating an example of a scheduling method of a multicore system according to an embodiment of the present disclosure.

Referring to FIG. 10, at step 1010, the hypervisor of the multicore system may measure frequency of input/output requests of each of all the Virtual Machines. At 1020, the hypervisor may determine whether or not there is a Virtual Machine of which the measured frequency of input/output requests is or more than the predetermined threshold value.

If there is no Virtual Machine of which the measured frequency of input/output requests is or more than the predetermined threshold value, at step 1025, the hypervisor may determine whether or not the current scheduling cycles of the cores are short. If the scheduling cycles of all the cores are not short, the hypervisor may end the process. However, if at least one scheduling cycle is short, at step 1027, the hypervisor may recover the scheduling cycle of that core. That is, the hypervisor may set the scheduling cycle of that core to be longer.

Furthermore, if it is determined at step 1020 that there is a Virtual Machine having frequency of input/output requests that is or more than the predetermined threshold value, at step 1040, the hypervisor may move the Virtual Machine to the same core as the core where the Dom0 Virtual Machine is being executed.

In an embodiment, if it is determined at step 1020 that there is a Virtual Machine having frequency of input/output requests that is or more than the predetermined threshold value, at step 1030, the hypervisor may determine whether or not the Virtual Machine is being executed in the same core where the Dom0 is being executed. If it is determined that the Virtual Machine is not in the same core as the Dom0, at step 1040, the hypervisor may move the Virtual Machine to the same core where the Dom0 Virtual Machine is being executed. However, if the Virtual Machine is already in the same core as the Dom0, the hypervisor need not move the Virtual Machine.

Then, at step 1090, the hypervisor may shorten the scheduling cycle of the core where the Dom0 belongs to. By doing this, the input/output performance of the Virtual Machine may be improved.

After the step 1040, in an embodiment, the hypervisor may find out frequency of input/output requests of each of other Virtual Machines existing in the core where the Dom0 exists, at step 1050. Furthermore, at step 1060, the hypervisor may determine whether or not there is a Virtual Core where the frequency of input/output requests is below the predetermined threshold value. If there is such a Virtual Core, the hypervisor may move the Virtual Machine to another core at step 1070. However, if there is no such Virtual Core, the hypervisor may shorten the scheduling cycle of the core where the Dom0 belongs to at step 1090.

Furthermore, after the step 1040, in an embodiment, the hypervisor may determine whether or not the scheduling cycle of the core where the Dom0 belongs to is short, at step 1080. If the scheduling cycle of the core where the Dom0 belongs to is not short, the hypervisor may shorten the scheduling cycle of the core where the Dom0 belongs to, at step 1090. However, if the scheduling cycle of the core where the Dom0 belongs to is short, the hypervisor may end the process. In an embodiment, the hypervisor may further shorten the scheduling cycle depending on the number of Virtual Machines being executed in the core where the Dom0 belongs to.

Meanwhile, the steps 1050 to 1070, and 1080 may be performed in the order illustrated in the figures or in an opposite order.

Although not illustrated, in an embodiment, the hypervisor may determine whether or not the number of Virtual Machines having an amount of input/output requests that is or more than the predetermined threshold value is or more than the predetermined number of Virtual Machines. Otherwise, the hypervisor may determine whether or not an idle Virtual Machine process capacity executable in the core where the Dom0 is being executed may accommodate the Virtual Machines of which an amount of input/output requests is or more than the threshold value. If the core where the Dom0 is being executed is not capable of accommodating all the Virtual Machines of which an amount of input/output requests is or more than the threshold value, or if the number of Virtual Machines of which an amount of input/output requests is or more than the threshold value is or more than the predetermined number of Virtual Machines, the hypervisor may shorten the scheduling cycles of other cores in addition to the core where the Dom0 is being executed. In such a case, without having to move the Virtual Machines of which the amount of input/output requests is or more than the threshold value to the core where the Dom0 is being executed, the hypervisor may retain the Virtual Machines in the other cores with a shortened scheduling cycle. Otherwise, in a case where there are at least two cores with a shortened scheduling cycle and a core with an unshortened scheduling cycle, the hypervisor may move the Virtual Machines of which an amount of input/output requests is or more than the threshold value to one of the two cores with the shortened scheduling cycle. Herein, moving the Virtual Machines having an amount of input/output requests that is or more than the threshold value may be performed sequentially in the order based on identification information of the Virtual Machines, or in the order based on the amount of input/output requests.

For example, the Virtual Machine having the most amount of input/output requests may be moved to the core where the Dom0 belongs to, and the Virtual Machine with a relatively small amount of increase of input/output requests may be moved to another core with a shortened scheduling cycle and not the core where the Dom0 belongs to.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A scheduling method of a multicore system, the method comprising:
measuring frequency of input/output requests of each of a plurality of Virtual Machines;
determining whether or not there is a Virtual Machine of which the frequency of input/output requests is or more than a predetermined threshold value;
moving, if frequency of input/output requests of a first Virtual Machine is or more than the predetermined threshold value, the first Virtual Machine to a first core where a Dom0 Virtual Machine is being executed; and
shortening a scheduling cycle of the first core where the Dom0 Virtual Machine is being executed according to a predetermined value.

2. The method according to claim 1,
wherein the moving the first Virtual Machine comprises, if a core where the first Virtual Machine is being executed is not the same as the first core where the Dom0 Virtual Machine is being executed, moving the first Virtual Machine to the first core.

3. The method according to claim 1,
further comprising, if frequency of input/output requests of a second Virtual Machine is smaller than the predetermined threshold value in the first core, moving the second Virtual Machine to a second core.

4. The method according to claim 1,
wherein the shortening the scheduling cycle of the first core comprises, if a scheduling cycle of the first core have not been shortened according to the predetermined value, shortening the scheduling cycle of the first core according to the predetermined value.

5. The method according to claim 1,
wherein the shortening the scheduling cycle further comprises:
determining whether or not the number of Virtual Machines of which an amount of input/output requests is or more than the predetermined threshold value is or more than a predetermined number of Virtual Machines; and
shortening, if the number of the Virtual Machines of which an amount of input/output requests is or more than the predetermined threshold value is more than the predetermined number of Virtual Machines, scheduling cycles of the first core and the second core according to the predetermined value.

6. A multicore system comprising:
a plurality of Virtual Machines (VMs);
a hypervisor configured to provide a virtualized execution environment for each of the plurality of Virtual Machines;
an input/output device; and
a plurality of cores configured to execute the plurality of Virtual Machines;
wherein the hypervisor measures frequency of input/output requests of each of the plurality of Virtual Machines, determines whether or not there is a Virtual Machine of which frequency of input/output requests is or more than a predetermined threshold value, and moves, if frequency of input/output requests of a first Virtual Machine is or more than the predetermined threshold value, the first Virtual Machine to a first core where a Dom0 Virtual Machine is being executed, and controls such that a scheduling cycle of the first core where the Dom0 Virtual Machine is being executed is shortened according to a predetermined value.

7. The multicore system according to claim 6,
wherein, if a core where the first Virtual Machine is being executed is not the same as the first core where the Dom0 Virtual Machine is being executed, the hypervisor controls such that the first Virtual Machine is moved to the first core.

8. The multicore system according to claim 6,
wherein, if frequency of input/output requests of a second Virtual Machine is smaller than the predetermined threshold value in the first core, the hypervisor controls such that second Virtual Machine is moved to a second core.

9. The multicore system according to claim 6,
wherein, if a scheduling cycle of the first core have not been shortened to the predetermined value, the hypervisor controls such that the scheduling cycle of the first core is shortened according to the predetermined value.

10. The multicore system according to claim 6,
wherein the hypervisor determines whether or not the number of Virtual Machines of which an amount of input/output requests is more than a predetermined number of Virtual Machines, and if the number of the Virtual Machines of which an amount of input/output requests is or more than the predetermined threshold value is more than the predetermined number of Virtual Machines, controls such that scheduling cycles of the first core and the second core are shortened according to a predetermined value.
